(19) United States
(12) Patent Application Publication
(10) Pub. No.: US 2002/0024669 A1
(43) Pub. Date: Feb. 28, 2002

(54) Spectral ellipsometer having a refractive illuminating optical system

(76) Inventors: Lambert Danner, Wetzlar-Naunheim (DE); Joachim Wienecke, Jena (DE)

Correspondence Address: Glenn Law, FOLEY & LARDNER, Washington Harbour, 3000 K Street, N.W., Suite 500, Washington, DC, 20007-5109, US

(21) Appl. No.: 09/893,709

(22) Filed: Jun. 29, 2001

(30) Foreign Application Priority Data
Jul. 11, 2000 (DE) 100 33 645.0

(51) Int. Cl. G01J 4/00

(52) U.S. Cl. 356/369

(57) ABSTRACT

The invention concerns a spectral ellipsometer having a refractive illuminating optical system (3) that is equipped with a small illuminating aperture and is designed for a wide wavelength region. By color correction of the illuminating optical system (3), a very small measurement spot (6) is generated on a specimen surface (4).

### CROSS REFERENCE TO RELATED APPLICATIONS

This invention claims priority of a German patent application DE 100 33 645.0 which is incorporated by reference herein.

### FIELD OF THE INVENTION

The invention concerns a spectral ellipsometer having a refractive illuminating optical system in accordance with the features in the preamble of claim 1.

### BACKGROUND OF THE INVENTION

Ellipsometers are based on a nondestructive optical measurement method in which the change in the polarization state of a light bundle reflected from a specimen surface is measured. For that purpose, light having a defined polarization state is generated in the ellipsometer and is directed, as a light beam that is as parallel as possible, at a specific angle onto the specimen surface. An illuminated spot called the “measurement spot” is created on the specimen surface. Corresponding to the properties of the specimen surface, the light reflected from the measurement spot possesses a modified polarization state (polarization ellipse) that is measured using a polarization analyzer with downstream photodetector. From this, the refractive index and absorption coefficient of the surface, and/or the thickness of a surface layer, can be determined. In the very commonly used single-wavelength ellipsometer, monochromatic light (usually in the visible wavelength range) is used.

In spectral ellipsometers, light of various wavelengths is used. With ellipsometric measurement at various wavelengths, it is possible to analyze complex structures such as multiple layers, inhomogeneous or anisotropic layers, etc. The refractive indices and absorption coefficients of multiple superimposed thin transparent surface layers, and/or their layer thicknesses, can be determined.

Instead of various wavelengths, various angles of incidence of the light bundle onto the specimen surface can also be used. A plurality of different angles of incidence yields a sufficient number of measured values so that all the material parameters of the surface layers can be calculated.

Determination of the material parameters of surface layers plays a particularly important role in the manufacture of semiconductor circuits on wafers. Ellipsometers are therefore among the devices used in the integrated circuit production process in order, for example, to ascertain the layer thicknesses of the surface layers. The progressive miniaturization of integrated circuits also requires a correspondingly small measurement spot.

Brochures of the company styled Sopra (www.sopra-sa.com of Oct. 21, 1999) disclose a spectral ellipsometer whose illuminating beam possesses a diameter of 3 mm. For the examination of very small specimen surfaces, the illuminating beam can be focused onto a microspot having dimensions of 100 μm×150 μm.

U.S. Pat. No. 5,166,752 discloses an ellipsometer in which parallel light rays in a ray bundle are converted, with the aid of a large aperture of an illuminating lens, into converging light rays, and thereby directed at differing angles of incidence onto a specimen. The light rays reflected from the specimen at correspondingly differing angles are detected simultaneously with a spatially resolving detector, thus making possible rapid detection of a large multiplicity of data from the differing angles. The use of the large-aperture illuminating lens makes it possible to achieve a small measurement spot, but it is known that this becomes smaller, the larger the aperture angle of the light rays, i.e. the more strongly the light rays converge. In addition to operating with monochromatic light, in another embodiment the ellipsometer can be operated with polychromatic light.

U.S. Pat. No. 5,608,526 discloses a spectral ellipsometer in which exclusively reflective optical elements are used in the beam path between the polarizer and analyzer of the ellipsometer, and with which small measurement spots can be achieved. The reason indicated for using a reflective rather than refractive optical system is that in the ellipsometer application, a transmissive optical system is not suitable for broadband UV radiation or for radiation from the UV to the near infrared.

### SUMMARY OF THE INVENTION

It is the object of the invention to describe a spectral ellipsometer, having a transmissive optical system, with which a sharply delimited measurement spot which is as small as possible, and has a diameter or length and width measurements on the specimen surface smaller than 100 μm, can be generated over a wide spectral range—from UV to near infrared—on the surface of a specimen.

This object is achieved, according to the present invention, by a spectral ellipsometer having a refractive illuminating optical system for an illuminating ray bundle, coming from an illumination unit, for generating a measurement spot on a surface of a specimen; and having a detector unit that receives and detects, as a measured ray bundle, the light reflected from the surface at the location of the measurement spot, wherein the illuminating optical system is color-corrected.

Advantageous embodiments and developments of the invention are evident from the dependent claims.

What has been recognized according to the present invention is that the hitherto minimally achievable size of the measurement spot in the context of spectral ellipsometers is not limited by spherical aberration, astigmatism, distortion, or other aberrations of the illuminating optical system, or by the divergence of the light ray bundle that is present; rather the limitation is caused by the chromatic aberration of the illuminating optical system. The color-corrected illuminating optical system that is accordingly manufactured furnishes a measurement spot with a diameter from well under 100 μm to the range of less than 50 μm, for a wide spectral range from ultraviolet light through visible light to the near infrared.

Good color correction and thus a greatly reduced spot size are already achieved with a lens doublet. In this context, the aperture of the lens doublet is kept small. The entrance and exit aperture of the fully illuminated lens doublet is determined by the unobstructed opening of the lens, and this determines the angular region of the illuminating ray bundle incident on the specimen surface. A small illuminating aperture yields accurate ellipsometric measurement results and also short calculation times for analysis of the ellipsometric measurements. The requirement for accurate and rapid measurements exists, for example, on the production line in semiconductor manufacturing, in order to attain a high product throughput.

Too small an aperture, however, results in diffraction effects because of the outer boundary of the illuminating optical system, causing the edge of the measurement spot to become unsharp. The unsharp edge regions can, however, unintentionally illuminate areas that are adjacent to the actual measurement location. The false light produced in such a case results, in some circumstances, in erroneous measurements.

Unsharp illuminated regions are thus eliminated by an illuminating aperture which exhibits no substantial diffraction effects. For a slightly larger illuminating aperture of this kind, the color correction of a lens doublet is in some circumstances not sufficient. It has been found that in the context of a compromise for a suitable illuminating aperture size, a color correction that is optimum for use in the spectral ellipsometer is achievable with a lens triplet. With this, a sufficiently small and sharp measurement spot, which can even be less than 50 μm in diameter, can be achieved.

A greater number of corresponding lenses can, of course, also be used for the color-corrected illuminating optical system; this allows a further improvement in the correction of chromatic aberration and also of other aberrations. On the other hand, a multiple-lens arrangement naturally means slightly lower overall transmission and a greater design outlay and cost.

The individual lenses of the color-corrected illuminating optical system can be aligned with one another by way of a precisely machined mount, and held at specific distances from one another. Preferably the lenses are manufactured in such a way that they are cemented to one another and thus can form a compact unit. The cement as well as the lens material must of course exhibit sufficient transmission for the light in the aforesaid wavelength range, in particular including the UV range. An additionally applied anti-reflection coating of the lenses further increases transmission; it has been possible, in this context, for the undesirable changes in the polarization state of the light which otherwise occur, especially upon refraction at the air-glass interfaces, to be greatly reduced.

For reception of the measured radiation reflected from the specimen surface, it is also advantageous to use a color-corrected optical system as the receiving optical system in the measured beam path of the ellipsometer. Color correction results in uniform illumination of the detector in a detector unit of the ellipsometer, thereby eliminating large differences in intensity between adjacent points on the detector. When light-guiding fibers that guide the received light to the detector inside the detector unit are alternatively used, uniform illumination of the entrances of the light-guiding fibers is also advantageous. Equally advantageous is uniform illumination of the monochromator which effects spectral dispersion of the light in the detector unit of the spectral ellipsometer.

With the use of the color-corrected refractive illuminating optical system in conventional spectral ellipsometers, microscopically small surfaces can be examined ellipsometrically over a wide wavelength range. This is especially important in the case of coated semiconductor surfaces for the manufacture of integrated circuits. In this context, the illuminating optical system according to the present invention makes it possible to determine the material properties and layer thicknesses of the surface layers over substantially smaller surface regions than was hitherto possible with conventional spectral ellipsometers.

### BRIEF DESCRIPTION OF THE DRAWINGS

Exemplary embodiments of the invention will be explained in more detail below with reference to the drawings, in which:

FIG. 1 schematically depicts an ellipsometer having a color-corrected refractive illuminating optical system;

FIG. 2 schematically depicts an ellipsometer having a color-corrected refractive illuminating and receiving optical system; and

FIG. 3 schematically depicts an ellipsometer having lens doublets as the illuminating and receiving optical systems.

### DETAILED DESCRIPTION OF THE INVENTION

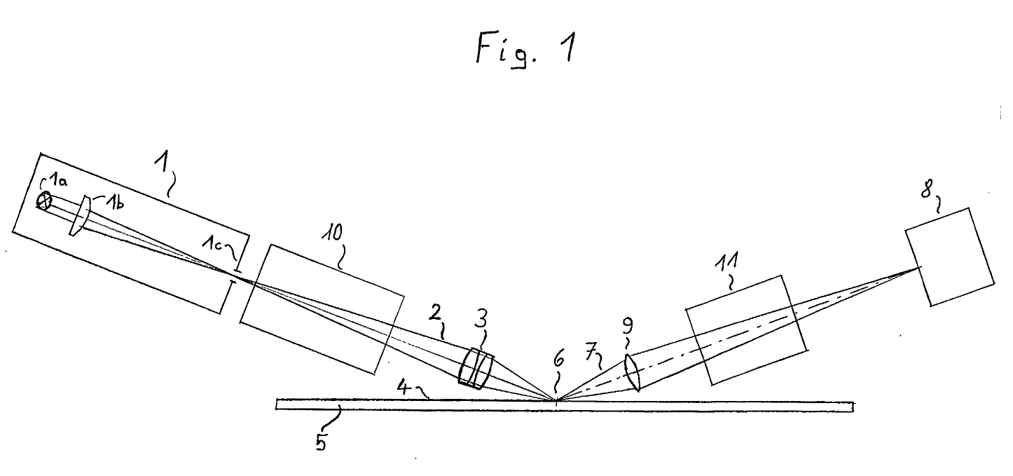

FIG. 1 schematically shows the construction of a spectral ellipsometer having an illumination unit 1, a polarizer group 10, an analyzer group 11, and a detector unit 8. In illumination unit 1, light is generated by one or more light sources 1a, and illuminates a field stop 1c by means of a collector 1b. The wavelength range of the light extends from UV through visible light to and including light in the near infrared range. Illuminating ray bundle 2 generated by illumination unit 1 enters polarizer group 10, in which it is brought into a defined polarization state.

Illuminating ray bundle 2 illuminates, via an illuminating optical system 3, a surface 4 of a specimen 5 in a measurement spot 6. In measurement spot 6, the light is reflected from specimen surface 4 and forms a measured ray bundle 7. An imaging optical system 9 serves to focus measured ray bundle 7. After passing through an analyzer group 11, measured ray bundle 7 is received and detected by a detector unit 8. The polarization state of measured ray bundle 7 is analyzed by means of analyzer group 11 and detector unit 8.

According to the present invention, a color-corrected refractive illuminating optical system 3 is arranged in the beam path of illuminating ray bundle 2. The light in illuminating ray bundle 2 is directed onto surface 4 with only a small angular region of the illuminating aperture.

In the exemplary embodiment of FIG. 1, the color-corrected illuminating optical system 3 according to the present invention is a lens triplet. This comprises three lenses as refractive optical elements with different refraction properties, which are configured in such a way as to correct, in particular, the longitudinal chromatic aberration (which results when light of different wavelengths passes through the refractive optical elements) and to generate a correspondingly small focus point as measurement spot 6.

Lens triplets are known per se, and generally provide improved imaging of an object by reducing optical aberrations such as spherical or chromatic aberrations. In the context of the subject matter of the invention, it was recognized that in a conventional ellipsometer with a refractive illuminating optical system, the measurement spot is limited to a diameter of 100 μm to 200 μm because of the longitudinal chromatic aberration. In this measurement spot size range, the longitudinal chromatic aberration represents most of the aberration. With the correspondingly color-corrected lens triplet 3, it has been possible to reduce the size of the measurement spot to a diameter of less than 50 μm. This corresponds to a reduction by a factor of at least four in the area of the measurement spot. The requirements for ellipsometric measurements with very small spot sizes together with a very wide wavelength range can thereby be met using a refractive illuminating optical system.

Lens triplet 3 shown in this exemplary embodiment according to FIG. 1 is cemented. Both the cement and the glass material of the lenses are appropriately designed for the wide wavelength range. High transmission is achieved in particular for the UV range. This is necessary because many UV light sources suitable for ellipsometers emit only a relatively low light intensity in the UV range.

An anti-reflection coating of lens triplet 3 also contributes to improved transmission. Anti-reflection coatings to enhance the transmission of refractive optics are commonly known, but the influence of the coating on the polarization state of the transmitted light must be taken into account. In lens triplet 3, this influence is so greatly reduced that the accuracy of the ellipsometric measurements is not thereby modified.

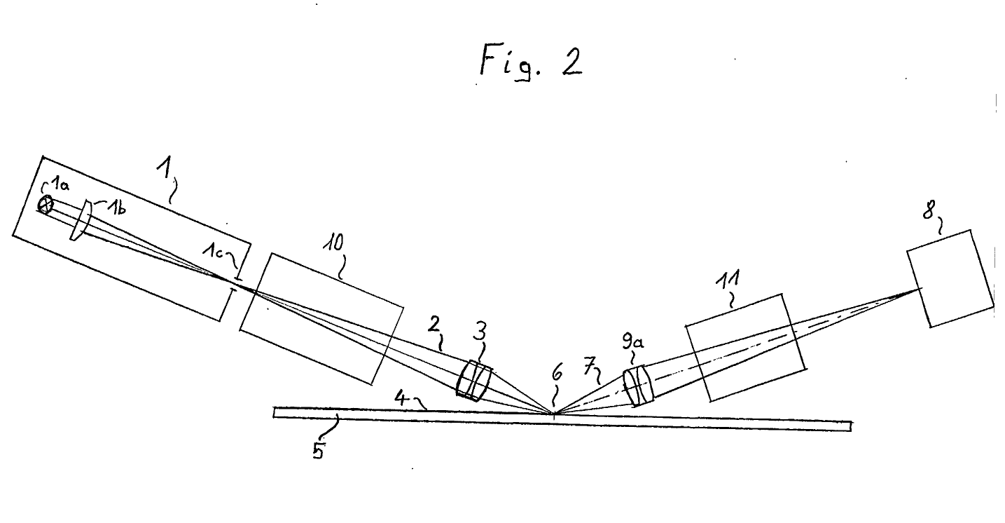

FIG. 2 also shows, in addition to the color-corrected illuminating optical system 3, a color-corrected receiving optical system 9a which is arranged in measured ray bundle 7 and replaces the conventional imaging optical system 9. In this exemplary embodiment, receiving optical system 9a is again made up of three lenses as refractive optical elements. Receiving optical system 9a can advantageously be of identical construction to illuminating optical system 3. In this case it is, for example, arranged with respect to illuminating optical system 3 in mirror-symmetrical fashion about measurement spot 6. The color-corrected illuminating optical system 3 and receiving optical system 9a are preferably constructed in such a way that they have no polarization-modifying effects. Failing this, a calibration would need to be performed. Color correction of receiving optical system 9a brings about, among other effects, a homogeneous illumination of the entrance of detector unit 8.

The color-corrected illuminating optical system 3 and receiving optical system 9a can, of course, also comprise more than three lenses in order to obtain further corrections and a further improvement in imaging.

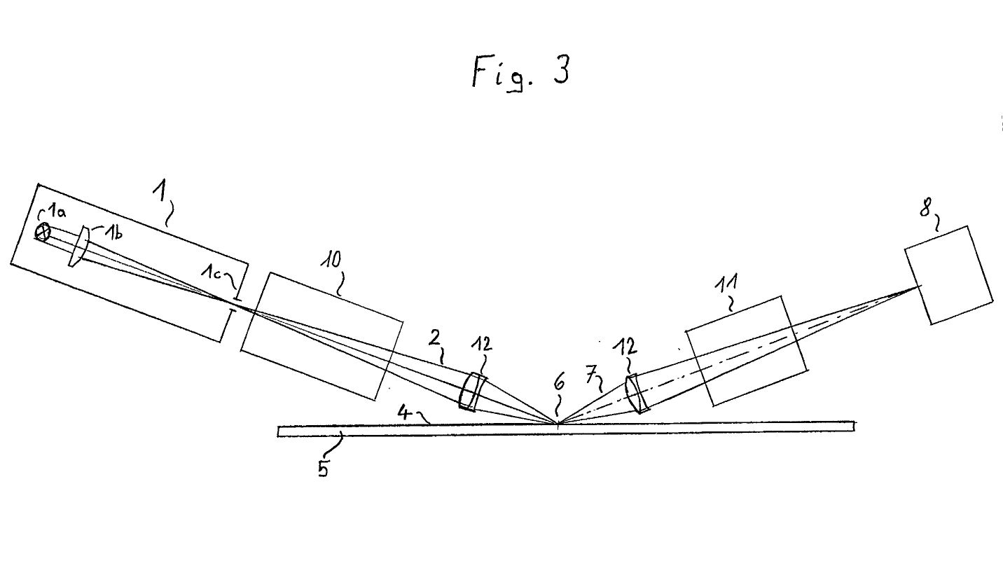

FIG. 3 shows the same arrangement with a spectral ellipsometer as in FIG. 2, lens doublets 12 being used instead of lens triplets (illuminating optical system 3, receiving optical system 9a) in the illuminating beam path and received beam path. The aperture of lens doublet 12 is slightly smaller than that of the lens triplet described in FIG. 2. On the one hand, this means that ellipsometer analysis is slightly easier; on the other hand, the color correction and small measurement spot size of the lens triplet cannot be entirely achieved.

### PARTS LIST

1 Illumination unit

1a Light source, light sources

1b Collector

1c Field stop

2 Illuminating ray bundle

3 Color-corrected illuminating optical system

4 Specimen surface

5 Specimen

6 Measurement spot

7 Received [sic] ray bundle

8 Detector unit

9 Imaging optical system

9a Color-corrected receiving optical system

10 Polarizer group

11 Analyzer group

12 Lens doublet

What is claimed is:

1. A spectral ellipsometer having a refractive illuminating optical system (3) for an illuminating ray bundle (2), coming from an illumination unit (1), for generating a measurement spot (6) on a surface (4) of a specimen (5); and having a detector unit (8) that receives and detects, as a measured ray bundle (7), the light reflected from the surface (4) at the location of the measurement spot (6), wherein the illuminating optical system (3) is color-corrected.

2. The spectral ellipsometer as defined in claim 1, wherein the color-corrected illuminating optical system (3) is a lens doublet or a lens triplet.

3. The spectral ellipsometer as defined in claim 1, wherein the color-corrected illuminating optical system (3) is made of glass having high transmission in the UV range and/or has an anti-reflection coating.

4. The spectral ellipsometer as defined in claim 1, wherein the color-corrected illuminating optical system (3) is constructed from individual refractive optical elements that are joined with a cement having high transmission in the UV range.

5. The spectral ellipsometer as defined in claim 1, wherein a receiving optical system (9a) that is color-corrected is provided for the measured ray bundle (7).

6. The spectral ellipsometer as defined in claim 5, wherein the color-corrected receiving optical system (9a) is a lens doublet or a lens triplet.

7. The spectral ellipsometer as defined in claim 5, wherein the color-corrected receiving optical system (9a) is made of glass having high transmission in the UV range and/or has an anti-reflection coating.

8. The spectral ellipsometer as defined in claim 5, wherein the color-corrected receiving optical system (9a) is constructed from individual refractive optical elements that are joined with a cement having high transmission in the UV range.

9. The spectral ellipsometer as defined in claim 1, characterized in that it is used to measure material parameters of thin layers applied onto the specimen surface (4).
